(19) United States
(12) Patent Application Publication
(10) Pub. No.: US 2014/0301624 A1
(43) Pub. Date: Oct. 9, 2014

(54) METHOD FOR INTERACTIVE THRESHOLD SEGMENTATION OF MEDICAL IMAGES

(71) Applicant: CIRCLE CARDIOVASCULAR IMAGING INC., Galgary (CA)

(72) Inventors: Philipp Barckow, Berlin (DE); Jason Chen, Calgary (CA); Kelly Cherniwchan, Calgary (CA); Matthias Friedrich, Dorval (CA)

(21) Appl. No.: 14/360,208

(22) PCT Filed: Nov. 26, 2012
(86) PCT No.: PCT/CA2012/050853

§ 371 Date: May 22, 2014

Related U.S. Application Data
(60) Provisional application No. 61/563,660, filed on Nov. 25, 2011.

(51) Int. Cl. G06T 7/00

(52) U.S. Cl. CPC G06T 7/0081; G06T 2207/30048
USPC 382/131

(57) ABSTRACT

A method of delineating a region of interest in a medical image and a system for carrying out the method. An initial point, corresponding to a pixel having an initial pixel intensity is selected on a desired region of interest in an image. A preliminary region of interest is delineated that includes the initial pixel and all connected pixels having a signal intensity in an initial range is delineated and displayed on the image. The initial range of signal intensities is adjusted based on user feedback. An adjusted region of interest is displayed. Also disclosed is a method of quantitatively analyzing a desired parameter in a region of interest of a medical image in real time and a system for carrying out this method.

### FIELD OF THE INVENTION

The present disclosure relates generally to image processing. More particularly, the present disclosure relates to interactive segmentation of medical images in preparation for quantitative analysis of structures from 2D, 3D or 4D image datasets such as X-Ray, Computed Tomography CT and Magnetic Resonance Imaging MRI.

### BACKGROUND OF THE INVENTION

Medical imaging is used as a diagnostic tool as well as an experimental tool to study the anatomy and physiology of humans and other animals. It is also used to guide targeted treatment of some illnesses, for example, cancer. Various medical imaging techniques include X-ray, ultrasound, radiation therapy, positron emission tomography (PET), magnetic resonance imaging (MRI), and computed tomography (CT).

Digital images obtained through these medical imaging techniques are processed to obtain anatomical and physiological information. One such process is known as segmentation, in which the digital image is partitioned into multiple segments to locate various objects and regions of interest within the image. The boundaries of a region of interest are typically marked by a line, which is displayed along with the image. This contour line may be used to determine basic calculations of the region of interest, such as calculating signal intensities, areas or volumes. Contours may be automatically generated or manually drawn by a user.

The manual creation of a contour line is time consuming and requires a high level of skill. For example, the quantitative analysis of cardiac MR images for areas, volumes and signal intensities requires, for most tasks, the identification of the endocardial border of the left and/or right ventricle (LV/RV) as well as the identification of papillary muscles inside the endocardial border. The definition of these contours is a highly important and time consuming task during the quantitative analysis of the images.

Methods of automatically generating contours are known. For example, U.S. Pat. No. 6,785,409 discloses a method of automatically generating contours to segment an image using thresholding. Van der Geest et al., (Van der Geest, R., Jansen, E., Buller, V., Reiber, J. 1994. Automated detection of left ventricular epi- and endocardial contours in short-axis MR images. In: Computers in Cardiology, Bethesda, Md., USA. Pp. 33-36) discloses the automatic detection of left ventricular and endocardial contours in short axis MR images using thresholding.

There are a number of difficulties associated with the automatic generation of contours. For example, due to the large number of acquisition techniques, the a priori assumptions of automatic segmentation algorithm are not applicable for all images because the images vary in signal intensity range and contrast. This variation depends on acquisition parameters and scanner manufacturers. Therefore the results of auto segmentation may not be accurate or the contour may not be optimally drawn. As a result, automatic segmentation methods often require manual adjustment of the results. Manual drawing is very time consuming especially if exact delineation of the region of interest is required.

A method of adjusting contours is disclosed in WO 2008/010134A2. With this method, a user is able to edit contours in a medical image by pushing and pulling a contour line that has been automatically generated. The method does not allow a user to generate contours.

Thus, there remains a need for a method of delineating a region of interest in a medical image that is quick, accurate and allows a user to interactively adjust the contour.

### SUMMARY OF THE INVENTION

Disclosed herein is a method for automatically identifying a region of interest which addresses at least one disadvantage from the prior art.

Disclosed is a method of delineating a desired region of interest in a medical image comprising: selecting a point within the region of interest, the point corresponding to an initial pixel having an initial pixel signal intensity; identifying an initial range of signal intensities including the initial pixel signal intensity; delineating a preliminary region of interest on the image that includes the initial pixel and all connected pixels having a signal intensity in the initial range; adjusting the initial range of signal intensities; delineating an adjusted region of interest on the image that includes all connected pixels having a signal intensity in the adjusted range; and finalizing the adjusted region of interest to delineate the desired region of interest. Optionally, the method may comprise re-adjusting the adjusted range of signal intensities; and re-delineating the adjusted region of interest until the desired region of interest is delineated.

Also disclosed is a method of quantitatively analyzing in real time a desired parameter in a region of interest of a medical image comprising: selecting an initial point on a desired region of interest in the image, the point corresponding to an initial pixel having an initial signal intensity; identifying an initial range of signal intensities that includes the initial pixel and all connected pixels having a signal intensity within the initial range; delineating a preliminary region of interest on the image that includes all connected pixels having a signal intensity within the initial range; calculating a parameter within the preliminary region of interest; displaying the calculation; adjusting the initial range of signal intensities; delineating an adjusted region of interest on the image that includes all connected pixels having a signal intensity in the adjusted range; recalculating the parameter within the adjusted region of interest; displaying the recalculated parameter; and, optionally, repeating the adjusting, delineating and recalculating steps until the region of interest is delineated.

A system for determining a region of interest in a medical image and a system for quantitatively analyzing a desired parameter in a region of interest of a medical image comprising a processor adapted to perform the methods disclosed herein are also described.

Other aspects and features of the present disclosure will become apparent to those ordinarily skilled in the art upon review of the following description of example embodiments in conjunction with the accompanying figures.

### BRIEF DESCRIPTION OF THE DRAWINGS

Embodiments will now be described, by way of example only, with reference to the attached Figures, wherein:

FIG. 1 is a flowchart of a method in accordance with an aspect of the present disclosure.

FIG. 2 shows segmentation of the endocardial and epicardial borders in a cardiac MR image, according to an aspect on the present disclosure.

FIG. 3 is a cardiac MR image showing segmentation of the myocardial chamber including trabecular structures according to an aspect of the present disclosure.

FIG. 4 is a series of cardiac MR images showing segmentation of a cardiac MR image, according to a further aspect of the present disclosure.

### DETAILED DESCRIPTION

Generally, the present disclosure provides a method and system for determining a region of interest in a medical image and a method and system for quantitative analysis of parameters in a region of interest in an image.

A method disclosed herein allows a user to analyze a medical image by delineating a region of interest on the medical image. A user may select an area within the region of interest and adjust in real time a contour line that is generated. The adjusted contour line may then be finalized by the user. The user may adjust and finalize the contour line without any knowledge of the method of threshold segmentation or analysis.

Also disclosed is a method of quantitatively analyzing in real time a parameter associated with a region of interest.

A “region of interest” as used herein is meant to include any area of an image that a user wishes to delineate. The region of interest may be an anatomical structure, for example an organ or tissue. A region of interest may also be, for example, scar tissue, edemic tissue, healthy myocardium, calcium deposits or a tumour.

A “parameter” is used herein to include any value that is to be calculated within the determined region of interest. The parameter may be, for example, an area, a volume, a volume over time, a signal intensity, a signal intensity over time, a distance or a distance over time.

A “user input” may be entered through any interface that allows a user to communicate with the processor. For example, the user input may be an input from a computer mouse, for example. The user may adjust the range of pixel or voxel intensities by depressing a button on a mouse (for example, a left or right click) or by adjusting a scroll wheel. The user input may also include a direct interaction between a user and a screen bearing an image, for example using a touch screen or any suitable tool such as a stylus.

As used herein the term “connected pixels” has the same definition as is commonly used in this art. Generally, it refers to pixels that touch each other on one or more border. This is a term that is known to a person of skill in the art.

For ease of understanding the method and system for determining a region of interest in a medical image will be described with the example of cardiac MR images in 2D space. However, the methods described herein are not limited to cardiac

MR images and may be applicable to any digital image, including for example, X-ray; ultrasound; radiation therapy; positron emission tomography (PET); magnetic resonance imaging (MRI); and computed tomography (CT) images.

Additionally, for ease of understanding, the methods described herein are described with the example of pixels, but the methods can also be applicable to analysis using voxels. A voxel is a volumetric pixel, or volume element, representing a value on a regular grid in three dimensional space. This is analogous to a pixel, which represents 2D image data in a bitmap.

Accordingly, the method is not limited to 2D images and may be used in analyzing multidimensional image datasets. For example, methods disclosed herein may be used in the analysis of medical images in 2D, 3D and 4D space.

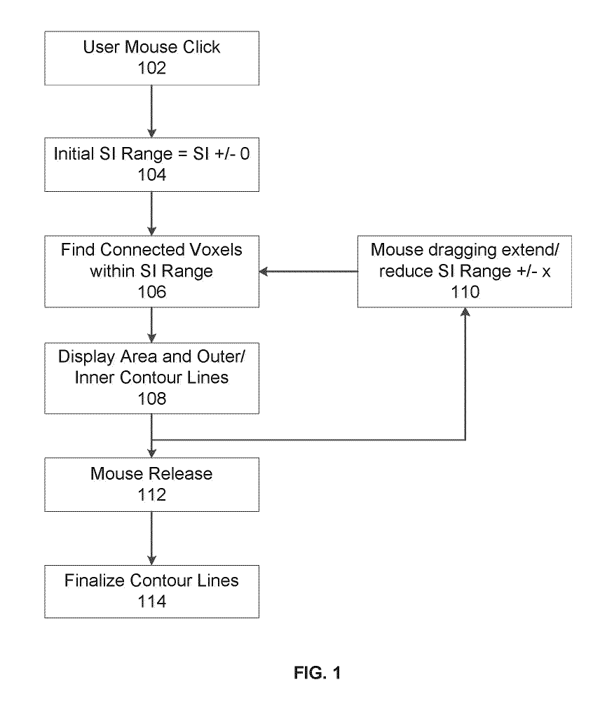

An embodiment of a method is outlined in the flowchart in FIG. 1. A digitized image or set of images is provided to a user via a user interface so that a user may use a method as disclosed herein to interactively determine a region of interest in the image or set of images. The images are preferably MR images, but other images may be analyzed using this method. A user may point to a structure in the image and adjust an upper and lower threshold in order to define an area by generating contour lines.

At action 102 an initial point is selected within a desired region of interest that is to be determined by a contour line. In FIG. 1 the point is selected by a user-driven mouse click within the region of interest, but any suitable means of selecting the point may be used. The initial point has a corresponding initial pixel or voxel signal intensity (SI) associated with it. At action 104, an initial SI range is established, wherein the range is equal to the initial SI +/−0 and includes the initial pixel or voxel signal intensity. At 106, connected pixels or voxels with a SI within the initial SI range are identified and at least one preliminary contour line is displayed at 108. A single contour line may be displayed or an inner or outer contour line may be displayed. Alternatively, multiple inner contour lines may be displayed.

The initial signal intensity range is adjusted by dragging the mouse (or any suitable input tool) up/down and/or left/right (or any direction). The range may be extended or reduced at step 110, and the range is equal to SI +/−x. As the range is adjusted, the contour line shown on the image will also adjust. The adjusted range may be increased or decreased by the user, in accordance with the visual feedback from the image. By adjusting this range, the user may determine the upper and lower thresholds which are defined by the signal intensity value of the pixel or voxel at the corresponding image coordinates of the mouse click event with the addition of signal intensity values which correlate to the amount of horizontal (lower/upper threshold definition) and vertical (upper/lower threshold definition) mouse movement. The preliminary contour may be readjusted until the desired region of interest is sufficiently delineated.

At step 112, the user provides an input which signals to finalize the contour line or lines. In this example, the mouse button is released. Once the input button (e.g., a mouse button) is released, the final contour line or lines are constructed based on the adjusted signal intensity range. The determined region of interest may then be analyzed.

For the extraction of the contour lines, the image data is interpolated based on the resolution of the display screen. Interpolation may be done using bicubic spline interpolation or other known methods for image interpolation. This interpolated data is transferred into a binary image using the defined signal intensity range (eg. all pixels or voxels in the signal intensity range are 1, all others 0). An outer contour line is extracted from the binary image data by generating the contour lines for connected pixels using a region growing algorithm with the initial image coordinates of the user input event as a seed. The resulting area or volume represents the region of interest or structure in the image, which was selected by the initial input.

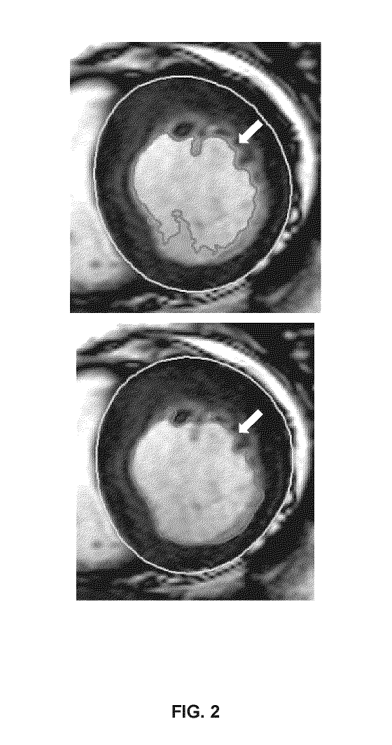

FIG. 2 shows the segmentation of the endocardial and epicardial borders in a cardiac MR image using the method described herein. In the top panel, a region of interest (in this case the endocardial border) has been delineated by a contour (see arrow). In the bottom panel the contour has been generated and adjusted using the method described herein. The user was able to more accurately determine the region of interest by adjusting the SI range to better define the region of interest (see arrow).

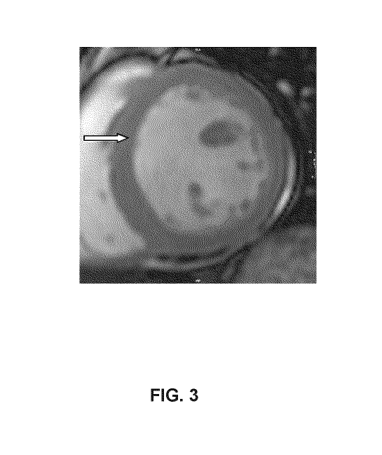

As described above, the method may optionally generate a second or multiple contour lines. The method may scan the first determined region of interest for areas which are not within the signal intensity range (set to zero in the binary image). Region growing and contour line extraction is performed for these areas to obtain an inner contour line or multiple contour lines. This is seen in FIG. 3, which shows a cardiac MR image that has been segmented according to the method described above. In this image, the region of interest is the LV bloodpool and is determined by the outer contour line (outer circle, denoted by the arrow), defining the endocardial border. The trabercular structures found with the myocardial chamber are defined by multiple inner contours, as shown by the inner circles.

In an embodiment, a multidimensional image is analyzed. In such a case, the described method is applied to all images of the dataset simultaneously (eg. to all images of a stack). Visual feedback is provided displaying the resulting contour lines in a multidimensional display (eg. 3D rendering).

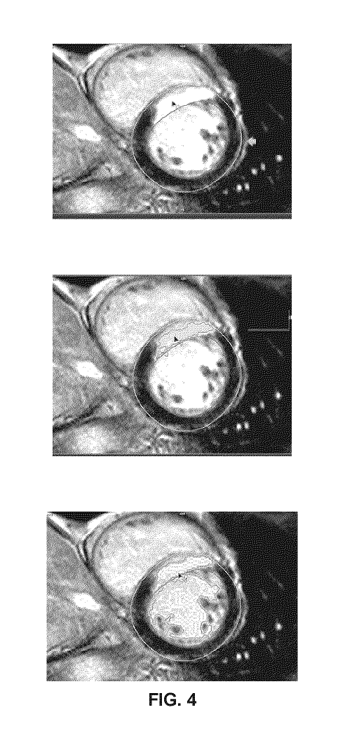

In an embodiment, the interactive thresholding segmentation analysis is first limited to a pre-defined area or volume in the image. The pre-defined area may be determined using the method described herein or by any known segmentation algorithm. In FIG. 4, the region of interest that the user wishes to analyze is a scar in the myocardium. In the top panel, the myocardium has been isolated through endo-(inner circle) and epi- (outer circle) cardial contours. By first isolating and predefining an area, the range of pixel intensities used to delineate the region of interest is limited to the pixel intensities of the pixels in the predefined area (i.e. the area between the endo- and epi-cardial contours) where the scar is located. Thus, a user is able to accurately delineate the region of interest (see the middle panel, small arrowhead), as the contour that is generated is limited to the predefined area (the area between the endo- and epi-cardial contours). In the bottom panel, the myocardium was not predefined, and the generated contour was not restricted to the myocardium.

As a further example, a user may be interested in a region of interest that is in a particular segment or volume of a blood vessel. The method disclosed herein may be used to define a region of interest such as a calcified or non-calcified plaque.

In an embodiment, the method may interactively calculate and recalculate in real time a parameter or set of parameters corresponding to the identified region of interest. The parameters may be determined by the user and may include calculating an area, volume, volume over time, signal intensity, signal intensity over time, distance or a distance over time. For example, as a user is selecting the left chamber of the heart as the region of interest, the method will calculate the volume of the selected region of interest. As the user adjusts the region of interest, the method will recalculate in real time the volume of the selected region of interest. This provides additional feedback to the user as the region of interest is selected. The result of the dependent calculations is presented as a text, graph or other applicable visual representation of the results.

Also disclosed is a system for delineating a region of interest in an image and a system for quantitatively analyzing a desired parameter in a region of interest of a medical image according to the methods described herein.

An embodiment is a computer program product, readable by a computer and containing instructions operable by a processor of a computer system to cause the processor to perform a method of delineating a region of interest in an image or a method of quantitatively analyzing a desired parameter in a region of interest of a medical image.

Embodiments can be represented as a software product stored in a machine-readable medium (also referred to as a computer-readable medium, a processor-readable medium, or a computer usable medium having a computer-readable program code embodied therein). The machine-readable medium can be any suitable tangible medium, including magnetic, optical, or electrical storage medium including a diskette, compact disk read only memory (CD-ROM), memory device (volatile or non-volatile), or similar storage mechanism. The machine-readable medium can contain various sets of instructions, code sequences, configuration information, or other data, which, when executed, cause a processor to perform steps in a method according to an embodiment of the invention. Those of ordinary skill in the art will appreciate that other instructions and operations necessary to implement the described invention can also be stored on the machine-readable medium. Software running from the machine-readable medium can interface with circuitry to perform the described tasks.

In the preceding description, for purposes of explanation, numerous details are set forth in order to provide a thorough understanding of the embodiments of the invention. However, it will be apparent to one skilled in the art that these specific details are not required in order to practice the invention. In other instances, well-known electrical structures and circuits are shown in block diagram form in order not to obscure the invention. For example, specific details are not provided as to whether the embodiments of the invention described herein are implemented as a software routine, hardware circuit, firmware, or a combination thereof.

The above-described embodiments are intended to be examples only. Alterations, modifications and variations can be effected to the particular embodiments by those of skill in the art without departing from the scope of the invention, which is defined solely by the claims appended hereto.

1. A method of delineating a desired region of interest in a medical image comprising:
selecting a point within the region of interest, the point corresponding to an initial pixel having an initial pixel signal intensity;
identifying an initial range of signal intensities including the initial pixel signal intensity;
delineating a preliminary region of interest on the image that includes the initial pixel and all connected pixels having a signal intensity in the initial range;
adjusting the initial range of signal intensities;
delineating an adjusted region of interest on the image that includes all connected pixels having a signal intensity in the adjusted range; and
finalizing the adjusted region of interest to delineate the desired region of interest.

2. The method according to claim 1, comprising:
re-adjusting the adjusted range of signal intensities; and
re-delineating the adjusted region of interest until the desired region of interest is delineated.

3. The method according to claim 1, wherein the steps of delineating a preliminary region of interest or delineating an adjusted region of interest comprises displaying a contour on the image around the preliminary or adjusted region of interest.

4. The method according to claim 1, wherein the delineated region of interest comprises two or more regions of interest, wherein each of the two or more regions of interest is defined by a contour.

5. The method according to claim 1, further comprising pre-defining an area which includes the desired region of interest.

6. The method according to claim 1, wherein the initial point is selected by an input.

7. The method according to claim 6, wherein the input is manually selected by a user.

8. The method according to claim 1, wherein the image is a cardiac magnetic resonance (MR) MR image.

9. The method according to claim 1, wherein the image is a set of images.

10. The method according to claim 9 wherein the set of images is a multidimensional set of images.

11. The method according to claim 10, wherein the pixel is a volumetric pixel.

12. The method according to claim 1, further comprising:
calculating a parameter within the preliminary or delineated region of interest; and
displaying the calculation.

13. A method of quantitatively analyzing in real time a desired parameter in a region of interest of a medical image in real time comprising:
selecting an initial point on a desired region of interest in the image, the point corresponding to an initial pixel having an initial signal intensity;
identifying an initial range of signal intensities that includes the initial pixel and all connected pixels having a signal intensity within the initial range;
delineating a preliminary region of interest on the image that includes all connected pixels having a signal intensity within the initial range;
calculating a parameter within the preliminary region of interest;
displaying the calculation;
adjusting the initial range of signal intensities;
delineating an adjusted region of interest on the image that includes all connected pixels having a signal intensity in the adjusted range;
recalculating the parameter within the adjusted region of interest;
displaying the recalculated parameter; and
optionally, repeating the adjusting, delineating and recalculating steps until the region of interest is delineated.

14. A system for delineating a region of interest in a medical image, the system comprising a processor adapted to perform the method according to claim 1.

15. A system for quantitatively analyzing a desired parameter in a region of interest of a medical image comprising a processor adapted to perform the method according to claim 13.

16. A non-transitory, tangible computer readable storage medium containing instructions operable by a processor of a computer system to cause the processor to perform the method according to claim 1.
